(19) United States
(12) Patent Application Publication
(10) Pub. No.: US 2011/0229606 A1
(43) Pub. Date: Sep. 22, 2011

(54) Candy with randomized, hidden images for game playing

(76) Inventors: Laurence Jay Shaw, San Francisco, CA (US); Jeffrey Raymond Miller, Mountain View, CA (US)

(21) Appl. No.: 12/803,319

(22) Filed: Jun. 24, 2010

Related U.S. Application Data
(60) Provisional application No. 61/342,259, filed on Apr. 8, 2010.
(60) Provisional application No. 61/340,509, filed on Mar. 17, 2010.
(60) Provisional application No. 61/337,480, filed on Feb. 4, 2010.
(60) Provisional application No. 61/280,179, filed on Oct. 30, 2009.
(60) Provisional application No. 61/271,457, filed on Jul. 20, 2009.
(60) Provisional application No. 61/269,529, filed on Jun. 25, 2009.

(51) Int. Cl. A23G 3/54

(52) U.S. Cl. 426/87; 426/383

(57) ABSTRACT

A candy for use as a game having multiple portions, e.g., layers or sections, bearing images of icons (messages, symbols, indicia, numbers, letters, etc.) which are revealed upon the consumption of the layers, or breaking away or consumption of sections. The images in the sequence of images on each candy are unpredictably (from the viewpoint of players) selected from a set of icons, and games such as Rock, Paper, Scissors may be played with two or more candies. In an alternate embodiment the icons are a heart, a bow and an arrow. If the candy is sectioned into break-away sections, then images are hidden from the opposing player(s) or all players by being located in recesses which become exposed when the sections are broken apart from each other or the main body of the candy. The break-away candy may have a vector or matrix geometry. If the candy is layered, the candy may be spherical with layers being concentric spherical shells with the images being printed on outside surfaces of the shells. Alternatively, the layered candy may be box shaped with layers being rectangular slabs and the images being deposited on the surfaces of the slabs or cast into the slabs.

### RELATED APPLICATIONS

The present non-provisional patent application is based on and claims the priority dates of provisional patent application filed Apr. 8, 2010 entitled “Candy with randomized, hidden images for game playing” by the same inventors, of provisional patent application filed Mar. 17, 2010 entitled “Candy with randomized, hidden images for game playing” by the same inventors, of provisional patent application Ser. No. 61/337,480 filed Feb. 4, 2010 entitled “Candy with hidden images for game playing” by the same inventors, of provisional patent application Ser. No. 61/280,179 filed Oct. 30, 2009 and entitled “Candy with hidden images for game playing” by the same inventors, provisional patent application Ser. No. 61/271,457 filed Jul. 20, 2009 and entitled “Multi-layer candy with hidden images for game playing” by the same inventors, and provisional patent application Ser. No. 61/269,529 filed Jun. 25, 2009 and entitled “Multi-layer candy with hidden images for game playing” by the same inventors.

### FIELD OF THE INVENTION

The present invention is directed to edibles, and more particularly to candies and confections, and is also directed to games and entertainments, is more particularly directed to edibles such as candies and confections that are played with and/or consumed in association with a game or entertainment, and is still more particularly directed to edibles such as candies and confections that bear hidden random images for use in game playing.

### BACKGROUND OF THE INVENTION

The idea of associating messages with food is not new. Fortune cookies and candies with messages printed on them (such as Sweethearts™ by Necco of Revere, Mass.) have existed for perhaps a century. However, the concept of a candy that bear multiple, random/unpredictable symbols, pictures, messages, or indicia for an entertainment, such as a game between multiple players, is not only new but compelling.

There are numerous fortune-telling games that have as their central feature random messages. Two such games are the Magic 8-Ball manufactured by Mattel Inc. of El Segundo, Calif. and the Ouija board manufactured by Parker Bros. of Pawtucket, R.I. A game which is widely played and relies upon message production is Rock, Paper, Scissors (RPS). In each round of the game of RPS two players simultaneously (usually on the count of three, or on the last syllable of roshambo, etc.) put out a hand representation of a rock (a closed fist) or a paper (an open palm) or a scissors (outstretched and separated pointer and index fingers). According to the rules of the game, “paper covers rock,” so if one person puts out a hand representation for paper and the other person puts out a hand representation for rock, the player who put out the hand representation for paper wins. Further, according to the rules of the game, “scissors cuts paper,” so if one person puts out a hand representation for paper and the other person puts out a hand representation for scissors, the player who put out the hand representation for scissors wins. And since “rock crushes scissors,” if one person puts out a hand representation for rock and the other person puts out a hand representation for scissors, the player who put out the hand representation for rock wins. However, if both players put out the same hand representation the round is a draw.

The prior art also includes candies and confections that have layers, such as the Tootsie Pop by Tootsie Roll Industries of Chicago, Ill., which is a sucker that has a hard candy exterior surrounding a chocolate center. When enough of the outside layer of a Tootsie Pop is consumed, the consumer experiences a taste change as he or she begins to taste the chocolate center. However, the transition between layers includes no message, signal, symbol, indicia, etc.

The prior art also includes candies and confections which are designed to be broken into sections. However, the sections of such prior art candies do not have hidden messages on them, and are not used for game playing.

It is therefore an object of the present invention to provide a candy which can be used for an entertainment, such as a game.

It is another object of the present invention to provide candies which can be used in groups of two or more for a game.

It is another object of the present invention to provide a candy which has a sequence of images associated with portions, which may be layers or sections, of the candy, the images being viewable as the layers are consumed or the section are broken apart or consumed by a consumer of the candy.

It is one more-particular object of the present invention to provide a candy which has a random or pseudo-random sequence of images associated with portions, which may be layers or sections, of the candy, the images being viewable as the layers are consumed or the sections are broken apart or consumed.

It is another object of the present invention to signal visual changes in a candy with taste changes.

It is another object of the present invention to signal visual changes in a candy with texture changes.

It is another object of the present invention to hide images within a candy using opaque layers or recesses or slots.

It is another object of the present invention to provide a candy with portions, which may be layers or sections, where a transition between portions includes an image of an icon (i.e., a message, signal, symbol, indicia, or the like) which can be used for game playing between two or more players.

It is another object of the present invention to provide candies which can be used in groups of two or more for a game or competition, particularly where each of the candies has a random or pseudo-random sequence of images associated with portions, e.g., layers or sections, of the candies, the images being viewable as the portions are consumed or broken away, and simultaneously visible groups of images are used for a round of the game or competition.

Furthermore, it is an important object of the present invention to provide a product line of candy entertainments, where candies in the various product lines differ with regards to, for instance, number of layers, number of sections, icons used, games played, flavors, geometries, or the like.

It is another object of the present invention to provide a candy which has multiple portions bearing a sequence of images, the images being hidden until the portions are consumed or broken away from each other or the main body of the candy by a consumer.

It is a more-particular object of the present invention to provide a portioned candy where each portion (e.g., each layer or section) bears a random/unpredictable image for use in game playing, the image on each portion being hidden from the opposing player(s) or both players (or all players if more than two players are involved) until the portion is consumed or broken away.

It is another object of the present invention to provide a unitary (i.e., integrally-formed) candy with hidden images which are revealed by an irreversible transformative process, such as the consumption or breaking away of portions.

It is another object of the present invention to provide a system for manufacturing candies bearing images pseudo-randomly selected from a finite set of icons.

Additional objects and advantages of the invention will be set forth in the description which follows, and will be obvious from the description or may be learned by practice of the invention. The objects and advantages of the invention may be realized and obtained by means of the instrumentalities and combinations particularly pointed out in the claims.

### SUMMARY OF THE INVENTION

The present invention is directed to an entertainment comprising a pair of edibles, such as candies, where each of the edibles has portions bearing images and portions which obscure the visibility of the images. The images become visible upon removal of neighboring portions. Image-bearing portions may or may not also serve as image-obscuring portions. The images are icons pseudo-randomly selected from a set of icons and consumers can play a game by comparing the sequence of images of their edibles.

The present invention is also directed to an entertainment comprising an edible, such as a candy, where the edible has portions bearing images visible upon removal of neighboring portions. The images are icons pseudo-randomly selected from a set of icons. The portions may be layers, such as layers of a lollipop, or break-away sections, such as sections of a linear or matrix geometry candy bar.

The present invention is also directed to a method for manufacturing edibles involving providing a base portion, pseudo-randomizing the alignment of an image printer relative to the base portion and printing an image of the icon on the image printer aligned with the base portion onto the base portion, providing an obscuring portion of the edible to hide the image printed on the base portion.

The present invention is also directed to a method for manufacturing edibles involving providing a substrate and a plurality of blocks. Each of the blocks bears an image of an icon with there being roughly the same number of heads with each of the icon images. The blocks are randomly selected and attached to the substrate so that the images are hidden by the proximity of neighboring blocks.

### BRIEF DESCRIPTION OF THE DRAWINGS

The accompanying figures, which are incorporated in and form a part of the present specification, illustrate embodiments of the invention and, together with the description given above and the detailed description of the preferred embodiments given below, serve to explain the principles of the invention.

FIG. 1A shows a cross-section of a spherical layered candy according to the present invention.

FIG. 1B shows an image for use in game playing on a background.

FIG. 2 flow-charts the process of manufacturing the candy of FIG. 1.

FIG. 3A shows another layered candy according to the present invention prior to the removal of any layers.

FIG. 3B shows the layered candy of FIG. 3A after a first layer has been removed so that a first image is visible.

FIG. 3C shows the substrate of a layer of the layered candy of FIG. 3A with a depression in the shape of an icon which the layer will bear.

FIG. 3D shows the layer of FIG. 3C with a candy material deposited in the depression in the substrate shown in FIG. 3C.

FIG. 4 is a flow chart of the process of manufacturing the candy of FIG. 3A.

FIG. 5A shows a candy with multiple bays with hidden images.

FIG. 5B shows a cross-section of a bay of the candy of FIG. 5A.

FIG. 6A shows a segmented candy with hidden images.

FIG. 6B shows a segment of the segmented candy of FIG. 6A.

FIG. 7A shows a perspective view of a sectioned candy bar for break-away play according to the present invention.

FIG. 7B shows a cross-sectional view of the sectioned candy bar of FIG. 7A.

FIG. 7C shows a perspective view of a single section of FIG. 7A.

FIG. 7D is a close-up view of a portion of the candy bar of FIG. 7A and a portion of an image stamper for imprinting images in the recesses between sections of the candy bar.

FIG. 7E shows the candy bar of FIG. 7A is a segmented wrapper used for promoting hygiene.

FIG. 7F shows a pair of candy bars packaged together in an opened candy wrapper.

FIG. 7G shows an alternate embodiment of the candy bar where gaps between sections are covered.

FIG. 7H shows a cross-sectional view of the candy bar of FIG. 7G along the long axis of the candy bar.

FIG. 7I shows a cross-sectional view of the candy bar of FIG. 7G along a short axis of the candy bar and through an internal hollow of the candy bar.

FIG. 7J shows another cross-sectional view of the candy bar of FIG. 7G along a short axis of the candy bar at a point which is not through an internal hollow of the candy bar.

FIG. 7K shows an exploded view of two of the components, the base and covering slab, of the candy bar of FIG. 7G

FIG. 8A shows a perspective view of a sectioned candy for break-away play according to the present invention having sections in a matrix arrangement.

FIG. 8B shows a cross-sectional view of the sectioned candy of FIG. 8A.

FIG. 8C shows another cross-sectional view of the sectioned candy of FIG. 8A.

FIG. 8D shows the candy of FIG. 8A with a section removed.

FIG. 8E shows a method of construction for the candy of FIG. 8A where sections are affixed to a substrate wafer.

FIG. 8F is a flow chart of the process of manufacturing the candy of FIG. 8E.

FIG. 9 shows three love/romance icons used for a game according to the present invention.

FIG. 10A shows modular blocks which are molded separately and then assembled to form the candy bar of the present invention.

FIG. 10B shows a covering slab and the modular blocks of FIG. 10A abutted to form an internal portion of the candy bar of the present invention.

FIG. 10C shows a cross-sectional view along the long axis of the abutted modular blocks and covering slab of FIG. 10B with a coating layer to hold the components together.

FIG. 11A shows an alternate embodiment of modular blocks which are molded separately and then assembled to form the candy bar of the present invention.

FIG. 11B shows the modular blocks of FIG. 11A abutted to form an internal portion of the candy bar of the present invention.

FIG. 11C shows a cross-sectional view along the long axis of the abutted modular blocks of FIG. 11B with a coating layer to hold the components together.

FIG. 12 shows a dispenser for dispensing candies having randomized images that are hidden until release from the dispenser.

### DETAILED DESCRIPTION OF THE PREFERRED EMBODIMENTS

While the idea of associating messages with food is not new, the concept of a candy that can produce random/unpredictable images that are icons (where “icon” is used in the present specification in a very broad sense to mean symbols, pictures, messages, indicia, or the like) for an entertainment, such as a game between multiple players is not only new but compelling. It should be noted that the present invention is generally applicable to any type of edible or confection, but for ease of description and readability the present specification describes the invention as a candy.

According to a first preferred embodiment, the candy of the present invention has layers which, when consumed, pseudo-randomly reveal one of the three symbols—rock, paper or scissors—so that the candy can be used to play the game Rock, Paper, Scissors (RPS.) Further examples of icons which each candy could display in a random/unpredictable sequence in association with a game are: die, dice, playing cards, playing card indices (rank and/or suit), etc.

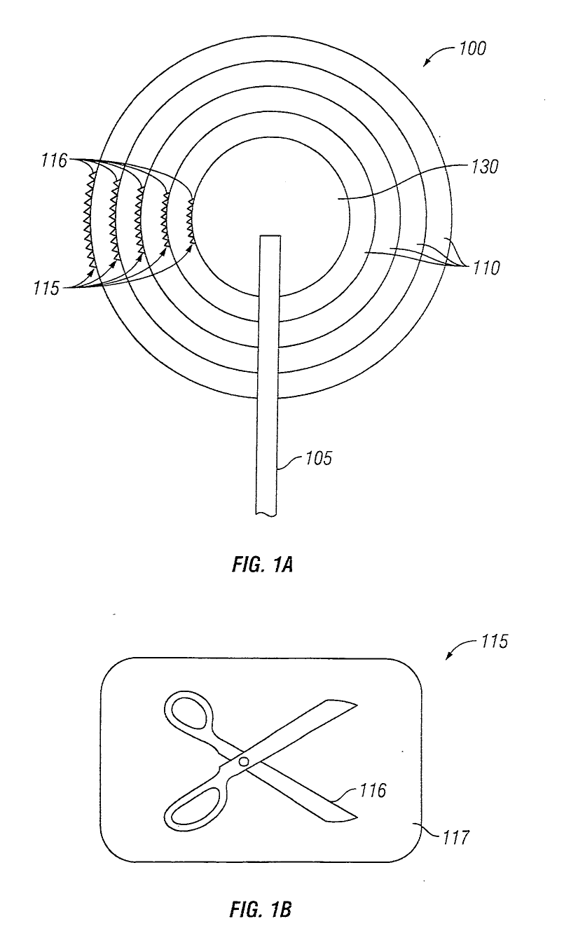

According to a first preferred embodiment shown in cross-section in FIG. 1A, the candy of the present invention is a sphere (100) mounted on a holder (105), i.e., a “sucker,” which is multi-layered. The holder (105) is made of wood, a stiff, rolled paper rod, or the like. The candy material from which the candy (100) is made is relatively hard so that the candy (100) is licked or sucked (rather than bitten into) during the course of its consumption so that the evolution of its size and shape is predictable. Around the base sphere (130) are a series of concentric substrate layers (110). The boundaries between substrate layers (110) is marked visually by an image (115) of an icon created by an edible “ink” (116) of a different color and/or texture than the color of the substrate layers (110). (Messages, symbols, indicia, pictures or the like applied to the surfaces of substrate layers (110) or incorporated in substrate layers (110) of the candy (100) will be generically referred to as icons in the present specification, and the particular icons applied to particular portions of the candy will be referred to as images.) Preferably, the ink (116) provides a noticeable flavor change when exposed to signal its exposure and visibility since the candy (100) may be within the mouth and not visible during consumption. (Alternatively, the flavor change signaling the exposure of a new image (115) may be produced by substrate layers (110) having different flavors.) Since the thickness of the ink (116) in the images (115) is considerably less than that of the substrate (110), and therefore the period of exposure/visibility is considerably shorter than that of the substrates (110), according to the preferred embodiment the ink (116) has a super sour flavor produced by a high concentration of citric acid to insure that the period during which the image (115) is visible is signaled by taste and thereby not missed. Although the ink (116) is referred to in the singular in the present description, a plurality of inks of a variety of colors may be used in combination with a corresponding plurality of stencils or other application devices to produce a color image. If the material of the substrates (110) is somewhat or fully transparent, the images (115) are printed over one another, i.e., printed to as to cover roughly the same range of solid angle, so as to obscure images (115) below. Alternatively, opaque layers may be included to obscure images.

According to the preferred embodiment, the image (115) consists of a positive-space portion which depicts the content of the message communicated by the image (115), and a negative-space/background area which has a circumference, such as a rectangle, which is the same shape and solid angle for each image (115). For instance, as depicted in FIG. 1B, the image (115) of a scissors consists of the message (116), which is of a scissors, against a negative-space/background (117) which has a rectangular outer circumference. Providing each image (115) with a background (117) of the same shape and solid angle obscures the messages (116) of those images (115) which are located further inside the candy (100).

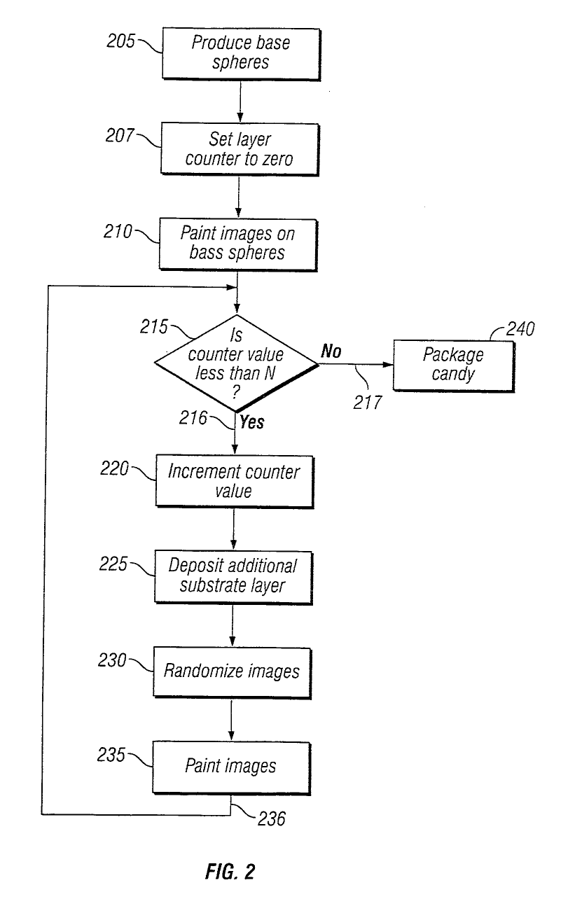

FIG. 2 provides a flowchart showing the process (200) of producing the candy (100) of the present invention. First, a number of solid base spheres (130) are produced (205) and a layer counter is set (207) to zero. Images are then printed or painted (210) on the base spheres (130) with edible ink (116) applied via stencils, stamps, rollers or the like. If multiple inks (116) of a variety of colors are used, then the inks (116) are applied using multiple stencils, stamps, rollers or the like (which will be referred to generically as stencils henceforth within the present specification) and allowed to dry. Next, the value in the layer counter is checked (215) and if it is (216) less than the total desired number of layers, N, the value in the layer counter is incremented (220) by one and the array of partially-produced candies (100′) is dipped into a vat of molten candy material and removed and allowed to set or harden to form (225) a substrate layer (110) for the next image (115). The thickness of a layer (110) is controlled by a combination of the temperature, and therefore viscosity, of the candy slurry, and the rapidity with which the partially-completed candy (100′) is dipped in the candy slurry.

Depending on the desired thickness of the layers (110), the candies (100′) may be dipped in the vat of molten candy material multiple times (not depicted in the flowchart of FIG. 2) prior to the application the next image (115). The thickness of the layers (110) and the consumption rate from sucking on the candy determines the pace of the exposure of images. According to the preferred embodiment, layers (110) are made of candy and have a thickness of between 0.5 mm and 2 mm, and more preferably roughly 1 mm, so as to allow exposure of each new image (115) within between 30 seconds and 2 minutes, and more preferably roughly 1 minute.

Then the next set of images is printed or painted (235) on the candies (100′). If the images (115) are to be used for game playing and are to be in a pseudo-random sequence on each candy (100), then a pseudo-randomization (230) of the stencils relative to the candies (100) must be performed prior to the painting (235) of the new images (115). This is accomplished by either utilizing a new set of stencils, or having the images on the stencils pseudo-randomly distributed and shifting the candies (100′) relative to the stencils or the stencils relative to the candies (100′). In the preferred embodiment, the candies (100) and stencils are arranged in a circle with the stencils having a pseudo-random ordering of images (115), and either the candies (100) or the stencils are rotated between paintings (235) of the images. (It should be noted that the manufacturing methods described in the present specification utilize pseudo-random processes to provide sequences of images which the consumers of the candies will experience as random, i.e., unpredictable. In other words, from the point of view of the manufacturer the candies coming off the production line have pseudo-random sequences of images, while from the point of view of the consumer the sequence of images in any particular candy is essentially random, i.e., unpredictable.)

Because the diameter and radius of curvature of the partially-completed candies (100′) changes in the course of production, the ink (116) of the images (115) is preferably applied with a stamp made of a sponge-like material which retains ink (115) and is deformable so as to adapt to the current radius of curvature of the currently-outer layer (110). According to the preferred embodiment, images (115) are roughly centered along the equator (199) of the candy (100). Furthermore, according to the preferred embodiment the base sphere (130) has a diameter of about 1.3 cm and the completed candy (100) has a diameter of about 2.5 cm, the images on the base sphere (130) and inner layers (110) have a diameter of about 0.8 cm, and the images on the outer layers (110) have a diameter of about 1.3 cm. According to the preferred embodiment, three or four sets of stamps of increasing size are used to adapt to the increasing diameter and radius of curvature of the candies (100′) in the course of production.

After the images (115) are painted (235), control returns (236) to testing (215) whether the counter value is less than the desired total number, N, of layers (110). If the counter value is not (217) less than the desired total number, N, of layers (110), then the desired number of layers (100) (and images (115)) has been created, so the completed batch of candies (100) is packaged (240). In one preferred embodiment, the final applied image (115) is a logo, brand name, or the like. Further randomization may be introduced by mixing completed candies (100) together in barrels or the like prior to grouping them in master packs of boxes or bags so that they are shuffled relative to their spatial arrangement during production.

Rock, Paper, Scissors (RPS) is a good example of the sort of game that can be played with the candies (100) of the present invention. If the outer layers (110) of the candies (100) are imprinted with a playing symbol, rather than the logo or brand name, then upon removing the wrappers of the candies (100) the two players can compare the exposed images (115) and a first round of RPS is played. Then, if the substrate layers (110) are substantially opaque, each player sucks on his or her own candy (100″) until detection of a change in flavor and/or texture signaling that the ink (116) has been reached and the next image (115) is exposed. (Partially-consumed candies are assigned reference numeral 100″.) If the substrate layers (110) are substantially transparent, each player sucks on his or her own candy (100) until detection of a change in flavor and/or texture signaling that the ink (116) has been consumed and the next image (115) is exposed. When both players have a new exposed image (115), they take the partially-consumed candies (100″) from their mouths to compare their images (115) using the rules of the conventionally-played game of RPS to see who has won this round of the game or whether this round is a tie. The players then put the candies (100″) back in their mouths and the process is repeated.

Another game which might be played with the candy of the present invention is a variation on the card game Black Jack. Each layer (110) may have the values, and possibly also the suits, of two playing cards printed on it. Upon exposure of the images (115) of each layer (110), players compare the sum of their card values and the player with the sum closest to 21 without going over 21 is the winner. For instance, if the card values exposed on a particular layer (110) of a first candy (100″) are a 7 and a 4, then that player has a sum of 11. If the card values exposed on a particular layer (110) of a second candy (100″) are a Q (i.e., queen) and a 7, then according to the rules of the game where face cards have a value of ten that player has a sum of 17. If the rules of the game are that the round is to end at this point, the owner of the second candy wins (100″). However, if the rules of the game are that each player has the option of “drawing” additional cards to add to his or her sum by exposing additional layers, the owner of the first candy (100″) might opt to expose one or two additional cards to increase his or her sum.

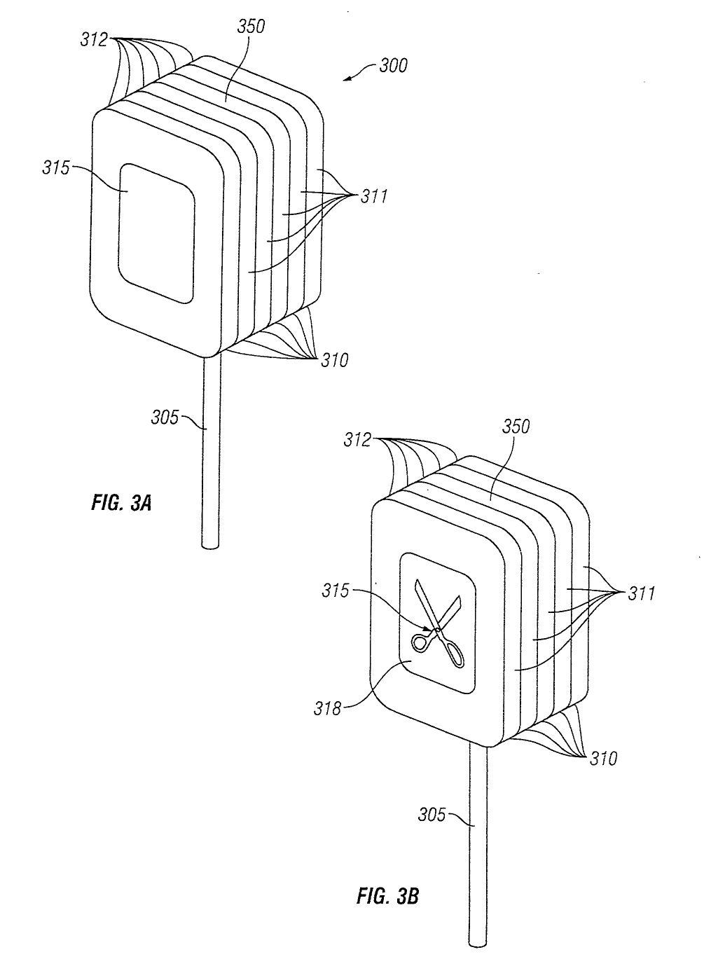

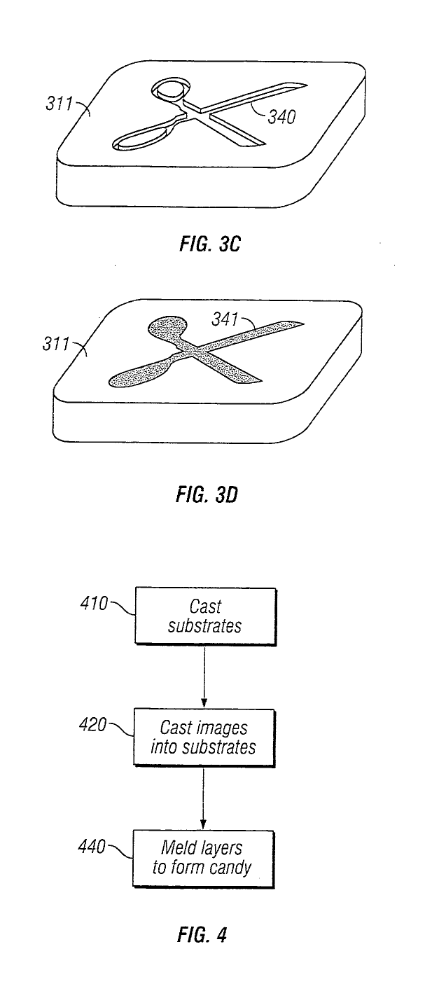

As depicted in FIG. 3A, in another preferred embodiment of the present invention the layers (310) of the candy (300) are planar slabs and a fusing process is used to meld the layers (310) into a completed multi-layer candy (300) mounted on a holder (305) made of wood or stiff paper. The layers (310) may be melded directly together, for instance via heat or pressure, or may be glued together with an edible glue (312). The edible glue (312) may be a sugar solution, a candy solution, molten sugar, molten candy, water, etc., and preferably the glue (312) provides a noticeable flavor change, for instance by having a super sour flavor. The candy material from which the candy (300) is made is relatively hard so that the candy (300) is licked or sucked (rather than bitten into) during the course of its consumption so that the evolution of its shape/geometry is predictable. As opposed to the previously described embodiment where the images (115) are located at boundaries between substrate layers (110), in this preferred embodiment the images (315) are cast into the layers (310). Since the images (315) have a thickness comparable to that of their surrounding substrates (311), and possibly equal to that of their surrounding substrates (311), the period of exposure/visibility of the images (315) is on the order of that of the substrates (311) and it is not necessary to incorporate a taste change to indicate when an image (315) is visible. However, it is advantageous to signal when a new image (315) is visible by a taste change, so according to the preferred embodiment of the present invention the candy material in each layer (310) from which the image (115) is made differs from those in the immediately adjacent layers (310). According to one preferred embodiment, the materials of the substrates (311) and/or images (315) are somewhat or fully transparent, while the edible glue (312) is opaque to obscure images (315) within the current outer glue (312) layer. According to another preferred embodiment, the glue (312) is transparent and the materials of the substrates (311) and images (315) (which might include frames (318) as discussed below, or might be printed on the surfaces of the substrates (311)) are opaque enough that images (315) below the current exposed image (315) are not visible.

As shown in FIG. 3B, according to another preferred embodiment using the rectangular slab geometry of FIG. 3A, each image (315) is located in a negative-space/background frame (318) with the shape of the frame (318) being the same in each layer (310). The candy material which forms the images (315) and the frames (318) are opaque, and the frames (318) in each layer are aligned so that images (315) in layers (310) below the currently exposed layer (310) are obscured. (It should be noted that layers (310) below a given layer (310) is synonymous with layers (310) further within a given layer (310) of the candy (300) until the candy (300) has been consumed down to being only one or two layers (310) in thickness.)

It should be noted that in consuming the multi-layer candy (300) of FIG. 3A, the shape will generally change from that of a box to a more rounded shape such as an ellipsoid. To insure that images (315) in each layer are sequentially exposed, the images (315) are roughly centered within their substrates (311) so that the normal vector to the layers (310) remains substantially parallel to the normal to the outer surface of the candy (300) as it is consumed.

The process of manufacturing the multi-layer candies (300) of FIG. 3A is shown in the flowchart of FIG. 4. First, the substrates (311) of the layers (310) are cast (410) from a first candy material. As shown in FIG. 3C, a substrate (311) may have an image-shaped depression (340) which does not extend to the bottom of the substrate (311) or, as shown in FIG. 3D, an image-shaped depression (341) which does extend to the bottom of the substrate (311). Then the images (315) are cast (420) into the depressions (340) or (341) by pouring a candy slurry of a second candy material into the depressions (340) or (341). To prevent the image candy slurry from altering the shape of the depressions (340) or (341), the melting temperature of the first candy material is higher than the melting temperature of the second candy material. It should be noted that for each candy (300) a central layer (350) which includes a recess (355), as shown in FIG. 3D, into which an end of the holder (305) is to be inserted, must also be cast. Then the layers (310) are shuffled or selected in a way to provide a random or pseudo-random ordering of images (315), and stacked—with the layer (310) having a recess (355) for the holder (305) located in the center of the stack, and with the holder (305) inserted into the recess (355)—and melded together (440) with the edible glue (312) to form the completed candy (300).

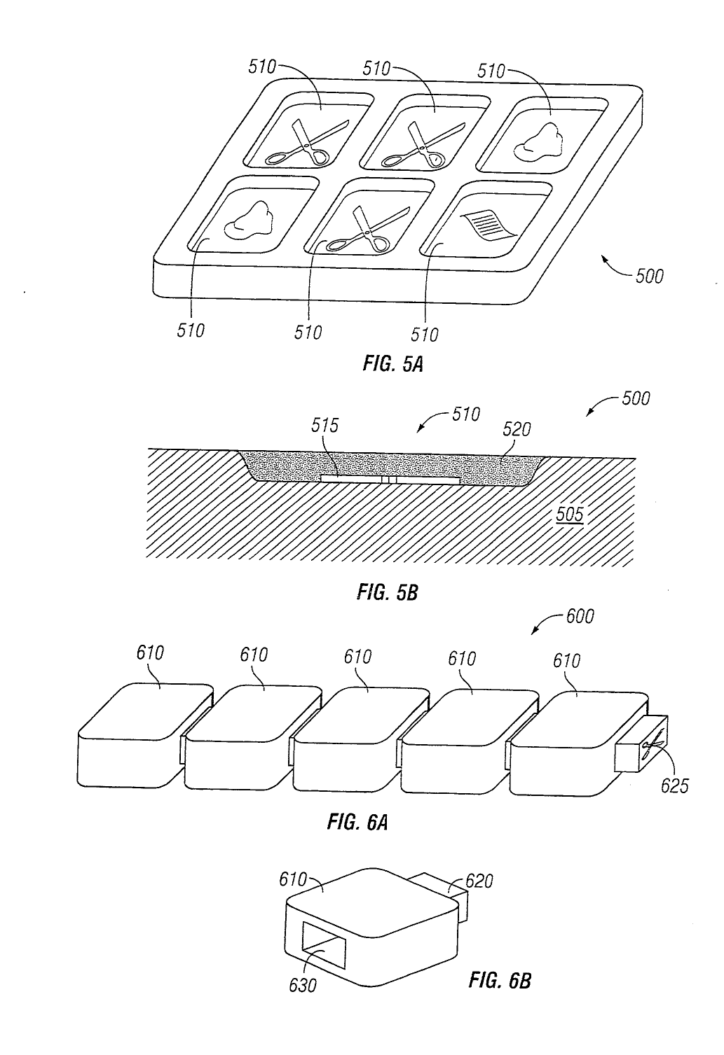

According to an alternate preferred embodiment depicted in FIG. 5A, the candy (500) of the present invention has a number of image bays (510) on its surface. As depicted in the cross-sectional view of an image bay (510) shown in FIG. 5B, an image (515) is printed on the substrate (505) of the candy (500) and the image (515) is covered by a visually-obscuring covering layer (520). The selection of images (515) is pseudo-random so that to a consumer the images (515) seem to be randomly chosen, i.e., unpredictable, so that games can be played when consumers expose their images (515) and compare them to images (515) exposed by one or more competing consumers. Each image (515) may be exposed by licking away the covering layer (520). To insure that the image (515) is not inadvertently removed in the process of removing the covering layer (520), the inks with which the image (515) is printed are much less readily removable than that of the covering layer (520). In the preferred embodiment, the substrate (505) is a hard candy such as rock candy, the image (515) are printed with edible inks of a hard candy colored with food colorings, and the covering layer (520) is powdered sugar.

According to another alternate preferred embodiment depicted in FIG. 6A, the candy (600) of the present invention has a plurality of separable segments (610). As shown in FIG. 6B where a single segment (610) of the candy is shown, each segment has a protruding part (620) are one end and a recess (630) at the other end. Inserting a protruding part (620) from one segment (610) into a recess (630) of another segment (610) provides a separable press fit, i.e., friction between the protruding part (620) and the recess (630) keeps the two segments (610) together until they are pulled apart. The end (622) of each protruding part (620) is flat, and printed on each flattened end (622) is an image (625). The sequence of images (625) in each candy (600) is pseudo-random—to a consumer the sequence of images (625) seems random, i.e., is unpredictable, so that games can be played when consumers expose their images (625) and compare them to images (625) exposed by one or more competing consumers.

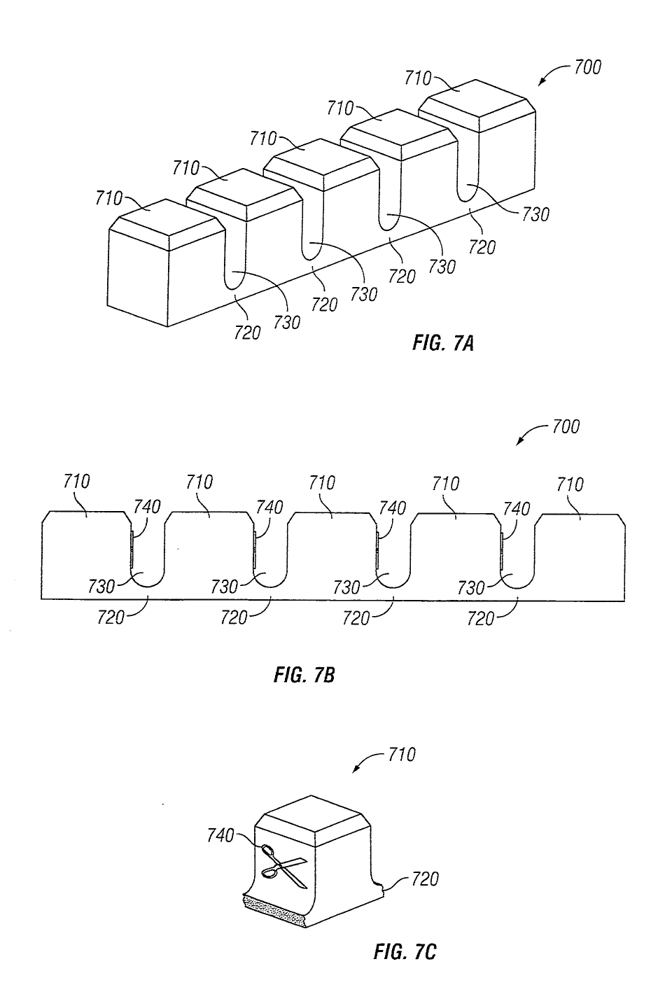

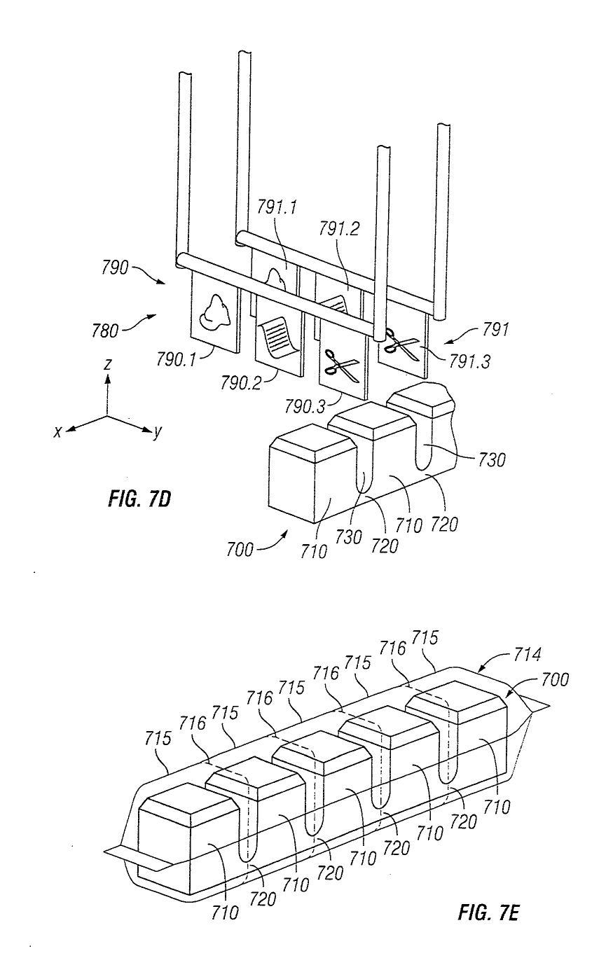

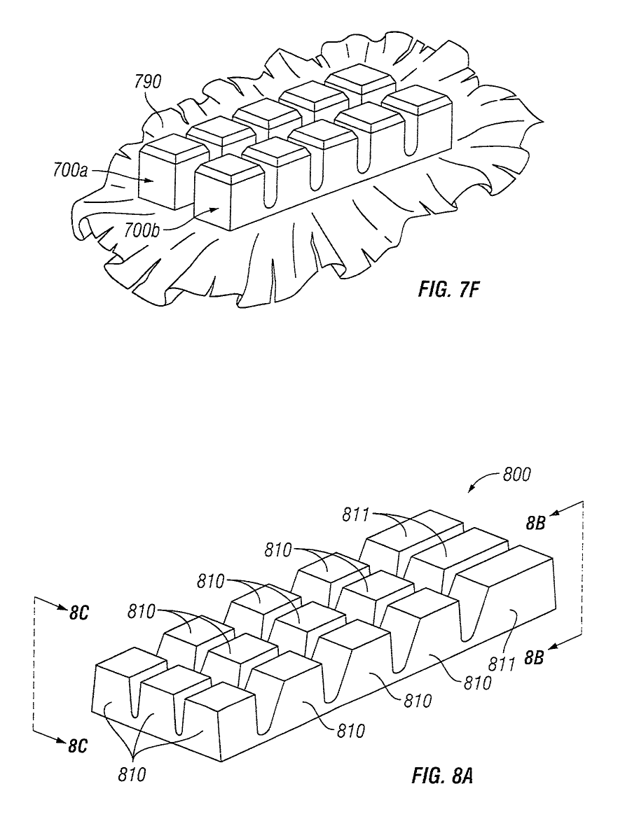

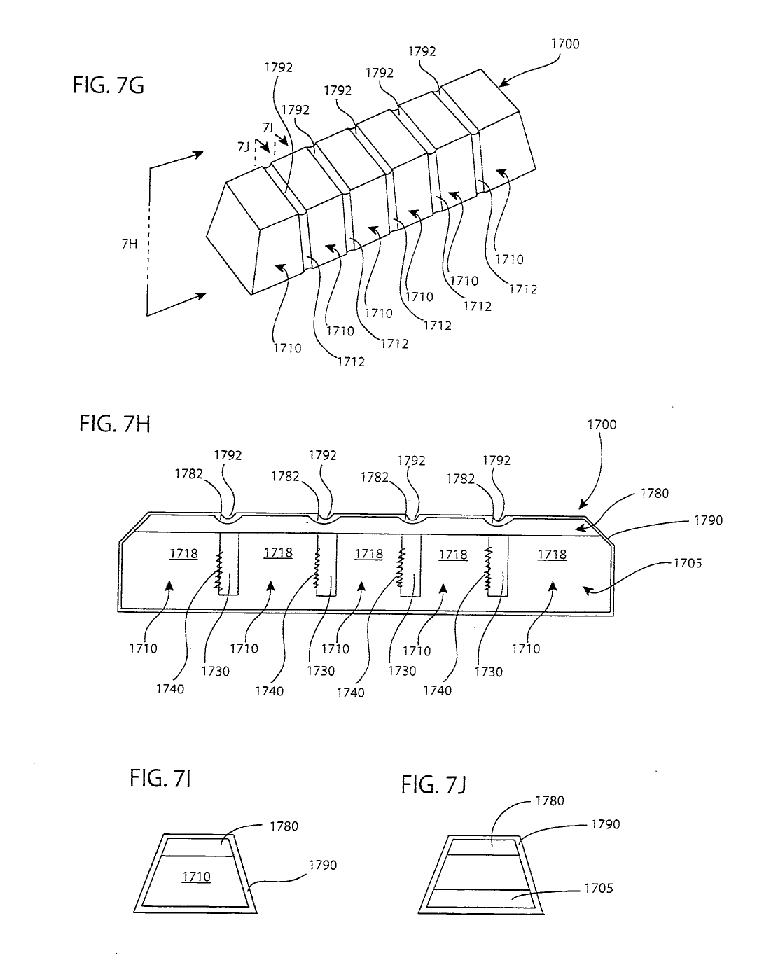

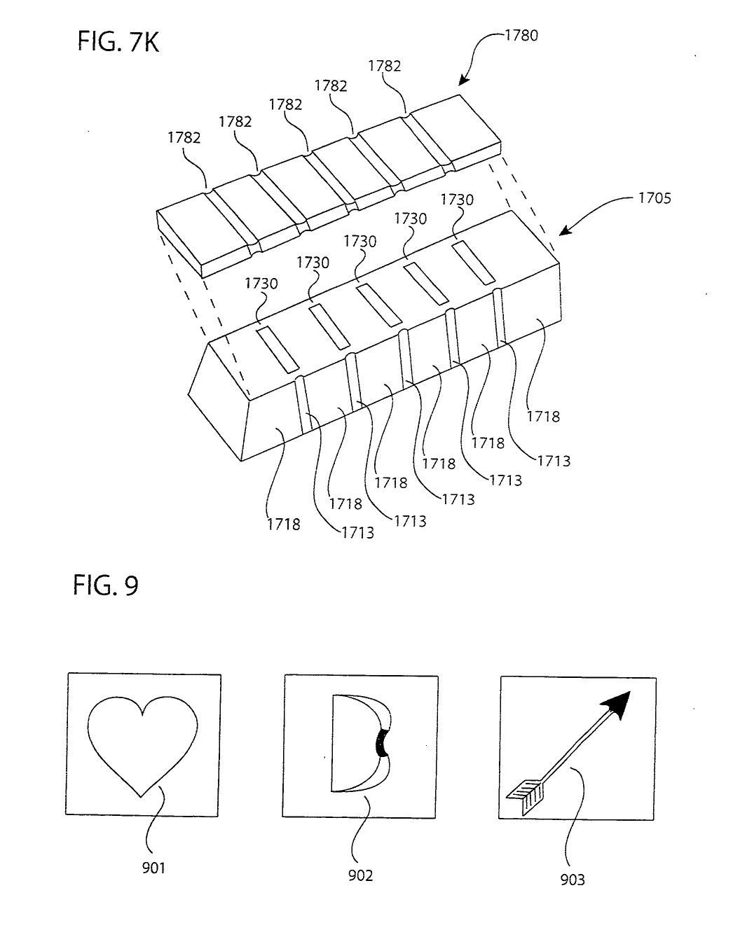

According to another alternate preferred embodiment depicted in perspective in FIG. 7A and in cross-section in FIG. 7B, the candy (700) of the present invention has a plurality of sections (710) connected by connecting regions (720), with the thinness of the connections regions (720) relative to the thickness of the sections (710) allowing the sections (710) to be broken apart from each other at the connecting regions. Between each pair of adjacent sections (710) above the connecting region (720) is a narrow recess (730). One face of a section (710) within each recess (730) bears an image (740). For each candy (700) the images (740) are pseudo-randomly selected from a finite set of icons. The section (710) which does not bear an image, which in the case of the candy (700) depicted in FIG. 7B on the far right side, is marked in some fashion to indicate that it (710) does not bear an image. For instance, the section (710) which does not bear an image may be marked with an edible ink, or may be of a different color or shape or size. FIG. 7C shows a lone section (710) of the candy (700), i.e., a section (710) that has been broken away from the rest of the candy (700). The recesses (730) are sufficiently narrow that the images (740) are difficult or impossible to see until the sections (710) are broken apart. According to the preferred embodiment the recesses (730) are deep enough and narrow enough that the images (740) printed on the interior faces of the sections (710) are not visible until the sections (710) are broken apart. In particular, according to the preferred embodiment the maximum angle φ between the plane of the face of a section (710) and the angle of viewing to the center of the image (740) is less than or equal to 0.3 radians, more preferably the angle of viewing to the center of the image (740) is less than or equal to 0.2 radians, and still more preferably the angle of viewing to the center of the image (740) is less than or equal to 0.1 radians. As shown in the close-up view of FIG. 7D, images are imprinted on the sections (710) by an image stamper (780) which consists of rows (790) and (791) of image stamps (790.1), (790.2), (790.3), (791.1), (791.2) and (791.3). FIG. 7D depicts two sections (710) of the candy (700) and two rows (790) and (791) of image stamps. Each row (790) and (791) has image stamps (790.1), (790.2) and (790.3) and (791.1), (791.2) and (791.3) bearing all the icons within the finite set of icons from which images (740) are selected. According to the preferred embodiment the regions on the stamps (790.1), (790.2) and (790.3) and (791.1), (791.2) and (791.3) where the images are located are raised or indented relative to the rest of the stamp (790.1), (790.2) and (790.3) and (791.1), (791.2) and (791.3). The stamps (790.1), (790.2) and (790.3) and (791.1), (791.2) and (791.3) are either inked with an edible ink or a heat stamp is used. For the embodiment shown in FIG. 7D, the leftmost stamp (790.1) in the closest row (790) bears the image of a rock, the center stamp (790.2) in the closest row (790) bears the image of a piece of paper, the rightmost stamp (790.3) in the closest row (790) bears the image of a scissors, the leftmost stamp (791.1) in the second row (791) bears the image of a rock, the center stamp (791.2) in the second row (791) bears the image of a piece of paper, the rightmost stamp (791.3) in the second row (791) bears the image of a scissors. Each row (790), (791) of stamps is connected to a three-dimensional computer-controlled servo (not shown). To select which image is imprinted on the first section (710), a pseudo-random number generator pseudo-randomly generates an integer between one and three (for instance, by pseudo-randomly generating an integer between 1 and a very large integer and taking its value mod 3) and shifts the row (790) of stamps (790.1), (790.2) and (790.3) along they direction so that the rock stamp (790.1) is above the closest recess (730) if the pseudo-random number is 1, the paper stamp (790.2) is above the closest recess (730) if the pseudo-random number is 2, and the scissors stamp (790.3) is above the recess (730) if the pseudo-random number is 3. Then the servo lowers the stamp (790.1), (790.2) or (790.3) in the first row (790) along the −z direction until it is in the recess (730), and then moves the stamps (790.1), (790.2) or (790.3) along the x direction to press against the face of the section (710) facing the recess (730). The row (790) of stamps (790.1), (790.2) and (790.3) is then removed by moving the row (790) of stamps (790.1), (790.2) and (790.3) back along the −x direction and up along the z direction in preparation for stamping the next candy to be placed under the stamper (780). An analogous process is used to stamp an image (740) in each of the remaining recesses (730) in the candy (700). By this pseudo-random stamping process, the image (740) on each section (710) is selected pseudo-randomly from n icons, and m sections (710) of each candy (700) bear images (740), so a manufacturing run will have roughly equal numbers of each of the n^{m} possible different combinations of ordered series of images (740). For example, for a candy bar having seven segments (m=7) stamped with icons for the game Rock, Paper, Scissors (i.e., n=3), the number of possible combinations of icons is 37=2187. An example of an ordered series of seven images in the game of Rock, Paper, Scissors would be: rock, scissors, paper, scissors, rock, rock, paper. Preferably n^{m}>30, more preferably n^{m}>100, still more preferably n^{m}>300, and still more preferably n^{m}>1000.

The result of the pseudo-random stamping process of the present invention is that the sequence of images (740) is unpredictable for the players, i.e., essentially random. If n^{m} is less than the number q of candies in the manufacturing run, then there will generally be some candies (700) with each sequence of images (740) with roughly the same number of each sequence of images (740). According to the present invention, if n^{m}<100 then the number r of ordered series of images (740) manufactured according to the preferred embodiment is r=n^{m}. Furthermore, if n^{m}<1000 then the number r of ordered series of images (740) manufactured according to the preferred embodiment is r=n^{m}. However, if nm is greater than the number q of candies in the manufacturing run, then some sequences of images (740) will not be produced. If n^{m}>q, then according to the preferred embodiment of the present invention r>q/2, more preferably r>3q/5, and still more preferably r is less than but roughly equal to q.

A variety of sets of icons can be used and, depending on the set of icons, play may be performed by two players or more than two players. Each pair of icons has an agreed-upon win-lose-draw relationship. For instance, for a game of Rock, Paper, Scissors played by two players, the players open their candies (700) and begin play by breaking a first section (710) off their candies (700) to expose a first image (740). Comparing their images (740), the two players determine who has won the round of play or if the round is a tie. The players may agree beforehand that if one player wins a round then the winning player wins the associated section (710) of the candy (700) from the losing player.

In an alternate preferred embodiment of the present invention the candy bar (700) has love/romance icons suited to, for example, a Valentine's Day version. According to the preferred embodiment the icons used for the love/romance embodiment are representations of a heart 901, a bow (902) and an arrow (903), as shown in FIG. 9. Since a bow shoots an arrow, the bow (902) triumphs over the arrow (903) when those two icons (902) and (903) come up in a round of play. Since an arrow pierces the heart, the arrow (903) triumphs over the heart (901) when those two icons (903) and (901) come up in a round of play. And since love is more powerful than war, the heart (901) triumphs over the bow (902) when those two icons (901) and (902) come up in a round of play.

The game played with candy bars (700) may involve the winner of each round acquiring the losing player's section (710). Because of hygiene concerns with regards to players winning other players' sections (710), each candy may include an inner wrapper (714) (in addition to a standard outer wrapper) which is sectioned into wrapper sections (715) separated by perforations (716) as shown in FIG. 7E. Although the wrapper (714) need not be transparent, for clarity of illustration the wrapper (714) is depicted in FIG. 7E as being transparent. The perforations (716) allow each section (710) of the candy (700) to be broken away with the inner wrapper (714) being simultaneously torn at the associated perforation (716). This allows for the section (710) to not be touched in the course of an exchanges between the players based on who has won the rounds, because the candy section (710) can remain inside its wrapper section (715) until after the exchange.

Because an important object of the present invention is that the candy (700) is used for game playing between two or more players, according to one preferred embodiment the candy is packaged in a packaging (790) in pairs (700a) and (700b) as shown in FIG. 7F. Although the pair of candies (700a) and (700b) shown in FIG. 7F do not have an inner wrapper (as shown in FIG. 7E), the packaging (790) may also include section-perforated inner wrappers.

According to an alternate preferred embodiment shown in perspective in FIG. 7G, in cross-section in FIGS. 7H, 7I and 7J, and in an exploded view of two of the components in FIG. 7K, the candy bar (1700) has multiple sections (1710) with hidden images (1740) but, in contrast with the embodiment depicted in FIG. 7A, the internal gaps (1730) between the sections (1710) are covered as an alternate means to prevent the images (1740) from being visible. In particular, the candy bar (1700) consists of a base (1705), a covering slab (1780), and an outer coating (1790). The base (1705) is segmented into multiple base sections (1718) with gaps (1730) between the base sections (1718). The face of at least one base section (1718) facing into each gap (1730) is imprinted with an icon for game playing using a randomization process such as that described above for the embodiment of the candy (700) depicted in FIG. 7A. The covering slab (1780) has troughs (1782) oriented transverse to the long axis of the covering slab (1780) and located directly above the gaps (1730) in the base (1705). Each side of the base (1705) has troughs (1713) oriented vertically and located alongside each gap (1730).

To assemble the candy bar (1700) the covering slab (1780) is placed on the base (1705), and the base (1705)/covering slab (1780) combination is turned over (relative to the orientations shown in FIGS. 7G, 7H, 7I, 7J and 7K) and dipped in a dipping material, such as chocolate. Because the openings of the gaps (1730) are located beneath the gaps (1730) during dipping and while the dipping material hardens, the dipping material does not flow into the gaps (1730). The troughs (1782) in the covering slab (1780) and the troughs (1713) in the base (1705), create troughs (1712) in the coating (1790) which extend up both sides of the candy bar (1700) and across the top. The troughs (1712) mark where the boundaries between candy sections (1710) are located, facilitating the application of breaking forces at the appropriate locations, i.e., at the gaps (1730) between sections (1710) of the candy bar (1700).

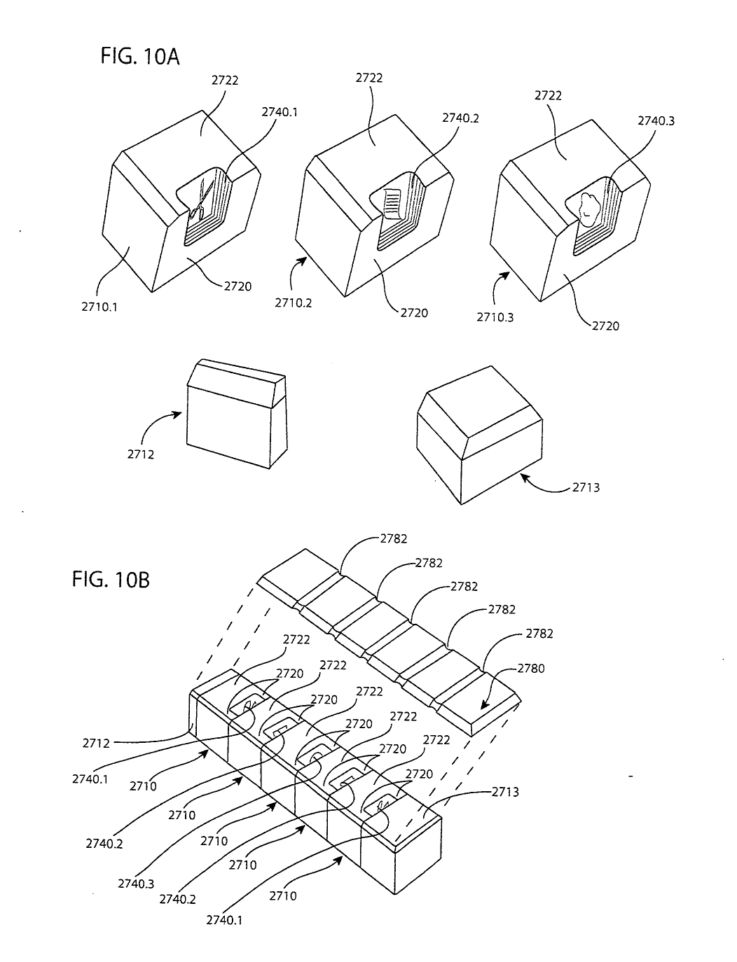

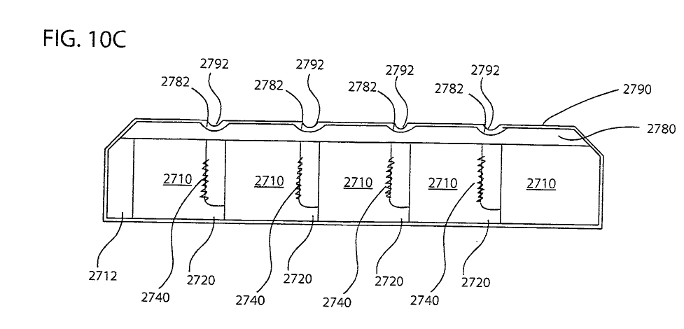

An alternate means for production of a candy bar (2700) according to the present invention uses the components shown in FIGS. 10A and 10B in lieu of the integrally-formed sectioned base (1705) described above and depicted in FIGS. 7G, 7H, 7I and 7J. Each candy bar (2700) includes a left-end cap block (2712), a plurality of image-bearing internal blocks (2710.1), (2710.2) and/or (2710.3), and a right-end block (2713). Each image-bearing internal block (2710.1), (2710.2) and (2710.3) is roughly box-shaped with an aspect ratio of roughly 1:1:1 and has a roughly box-shaped slot (2745) with an aspect ratio of roughly 4:4:1 on one face which bears an image (2740) and is open to the top surface of the block (2710.1), (2710.2) and (2710.3). Wings (2720) extending outwards from the sides and bottom of the image-bearing internal block (2710.1), (2710.2) and (2710.3) define the side and bottom walls of the slot (2745). (The images generically or collectively are assigned reference numeral (2740), and specific images are assigned reference numerals of the form (2740.n) where n is an integer. Similarly, image-bearing blocks generically or collectively are assigned reference numeral (2710), and blocks bearing specific images are assigned reference numerals of the form (2710.n) where n is an integer.) Molds which have no overhangs are cheaper and easier to produce and use. The geometry of each of the types of blocks (2710.1), (2710.2) and (2710.3) shown in FIG. 10A is such that they (2710.1), (2710.2) and (2710.3) can be molded in open-top molds having no overhangs. (Chocolate, for instance, is molded in open-top molds.) In particular, the back left faces (according to the orientations shown in FIG. 10A) of the blocks (2710.1), (2710.2), (2710.3), and (2713) would be the top surfaces of the blocks (2710.1), (2710.2), (2710.3), and (2713) during molding. And the back right face (according to the orientation shown in FIG. 10A) of the left-end cap block (2712) would be the top surface of the left-end cap block (2712) during molding.

FIG. 10B shows an assembly of the blocks (2710.n), (2712) and (2713) abutting to form a base portion (2701) of the bar (2700). At the left end is the left-end cap block (2712). The image-bearing internal blocks (2710) are all oriented with the slots (2745) facing rightwards. The covering slab (2780) is placed on the base portion (2701), as shown by the dashed guide lines in FIG. 10B, and the covering slab (2780)/base portion (2701) assembly is coated with a coating layer (2790) as shown in the cross-sectional view of FIG. 10C. The covering slab (2780) has transverse grooves (2782) at locations corresponding to the lines where the image-bearing internal blocks (2710) abut to indicate where the candy bar (2700) is to be broken to expose the randomized, hidden images (2740). According to the preferred method of production, the covering slab (2780)/base portion (2701) assembly is turned over relative to the orientation shown in FIG. 10B before being dipped into the coating material to insure that the coating material does not fill up the slots (2745). The resulting grooves (2792) in the coating layer (2790) produced by the grooves (2782) in the covering slab (2780) indicate where the candy bar (2700) is most readily broken.

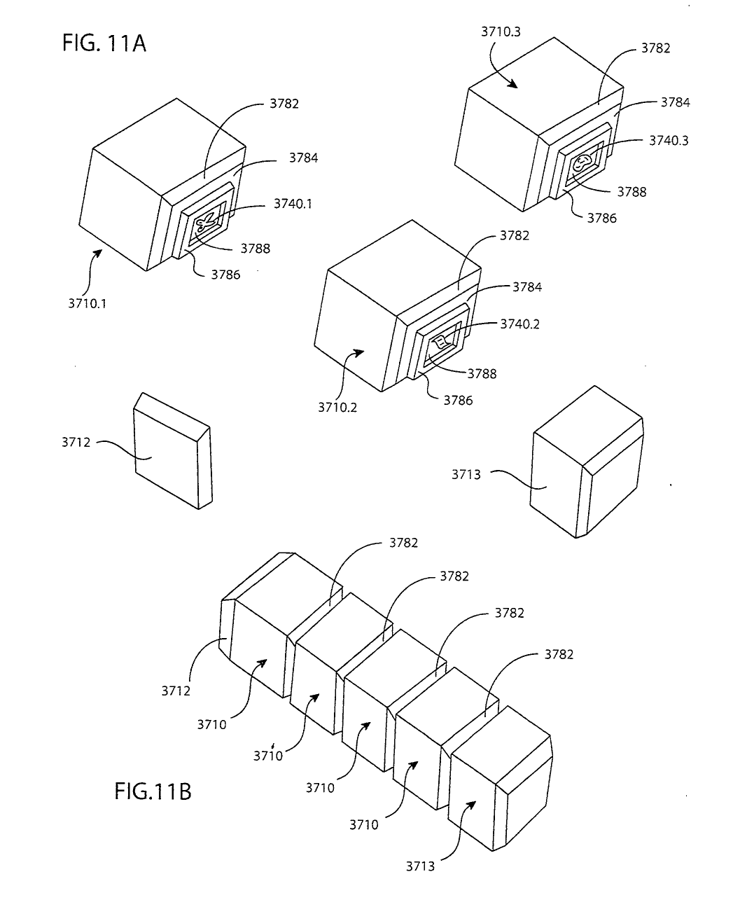

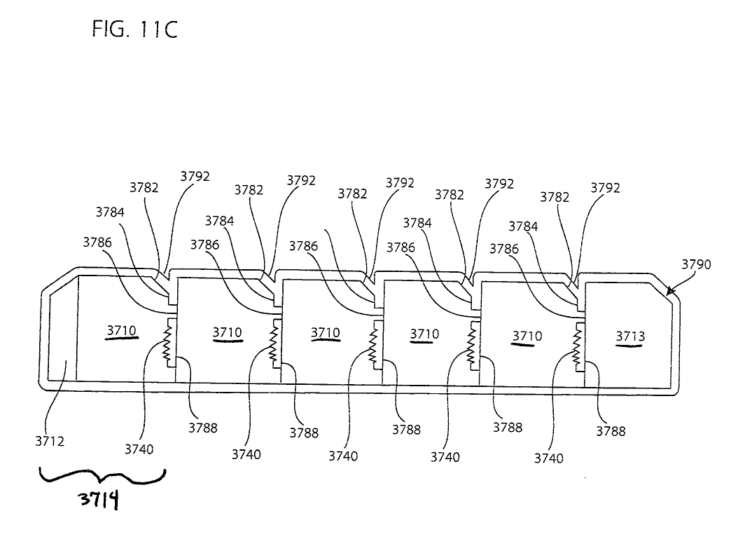

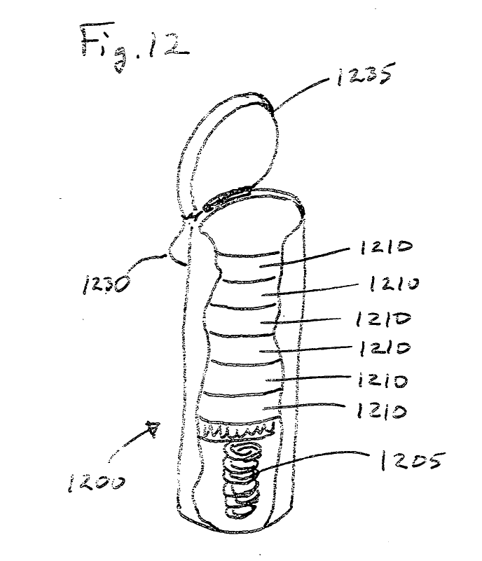

Another alternate means for production of a candy bar (3700) according to the present invention uses the components shown in FIGS. 11A and 11B in lieu of the integrally-formed sectioned base (1705) described above and depicted in FIGS. 7G, 7H, 7I and 7J. Each candy bar (3700) includes a left-end cap block (3712), a plurality of image-bearing internal blocks (3710.1), (3710.2) and/or (3710.3), and a right-end block (3713). Each image-bearing internal block (3710.1), (3710.2) and (3710.3) is roughly box-shaped and has a bevel (3782) around the image-bearing face (3784) that goes across the top of the image-bearing face (3784) and down each side edge. And image frame (3786) projects outwards from the image-bearing face (3784), and an image (3740.n) is molded on a recess (3788) within the frame (3786). (The images generically or collectively are assigned reference numeral (3740), and specific images are assigned reference numerals of the form (3740.n) where n is an integer. Similarly, image-bearing blocks generically or collectively are assigned reference numeral (3710), and blocks bearing specific images are assigned reference numerals of the form (3710.n) where n is an integer.) Molds which have no overhangs are cheaper and easier to produce and use. The geometry of each of the types of blocks (3710.n), (3712) and (3713) shown in FIG. 11A is such that they (3710.n), (3712) and (3713) can be molded in open-top molds having no overhangs. (Chocolate, for instance, is typically molded in open-top molds.) In particular, the back left faces (according to the orientations shown in FIG. 11A) of the blocks (3710.1), (3710.2), (3710.3), and (3713) would be the top surfaces of the blocks (3710.1), (3710.2), (3710.3), and (3713) during molding. And the back right face (according to the orientation shown in FIG. 11A) of the left-end cap block (3712) would be the top surface of the left-end cap block (3712) during molding.

FIG. 11B shows an assembly of the blocks (3710), (3712) and (3713) abutting to form the central portion of the bar (3700). At the left end is the left-end cap block (3712). The image-bearing internal blocks (3710) are all oriented with their image-bearing faces (3784) facing rightwards such that each image frame (3786) abuts the back left face of the block (3710) or (3713) immediately to the right. The assembly of blocks (3710), (3712) and (3713) is coated with a coating layer (3790) as shown in the cross-sectional view of FIG. 11C. The coating layer (3790) may be created by a molding process or an enrobing process. The bevels (3782) create indents (3792) in the coating (3790) to indicate where the bar (3700) is to be broken to expose the randomized, hidden images (3740.n). The coating also fills the regions between the image-bearing faces (3786) and the abutting blocks (3710) and (3713). The amount of surface area of the faces (3786) determines the strength of the bond between the blocks (3710) and (3713), and may be adjusted to provide a desirable bond that holds the blocks (3710) and (3713) together reliably yet provides a satisfying sound and feel when broken apart. The frames (3786) circumscribe and provide a seal around the images (3740.n) when the blocks (3710) and (3713) abut as shown in FIGS. 11B and 11C so the coating cannot reach the recesses (3788) or images (3740.n).

The extra length of the left end section (3714) produced by the left-end cap block (3714) is an indicator (as may also be explicitly stated on the packaging) that the game is to begin with the breaking off of the left end section (3714). (In contrast, if the right end section (3713) is broken off first, then the remaining bar, rather than the broken off piece (3713), would bear the exposed image (3740).)

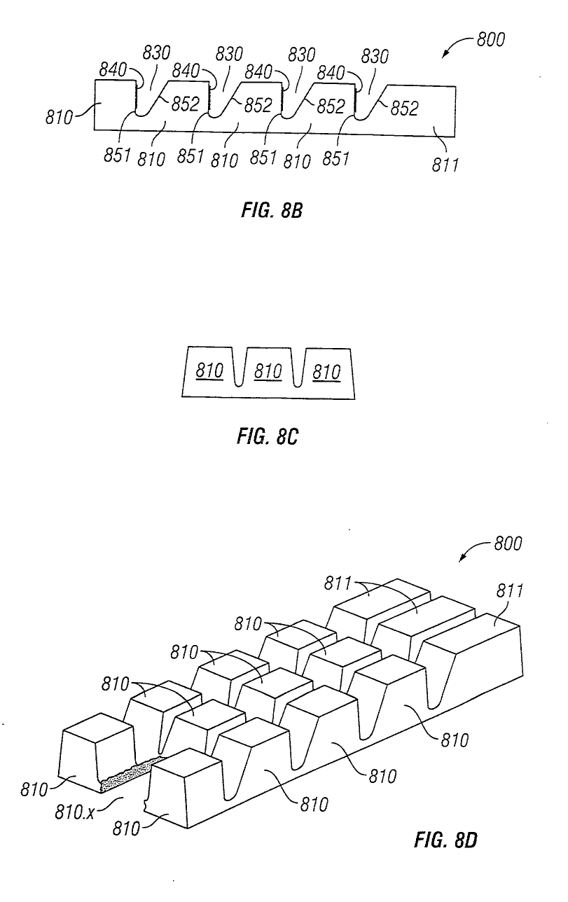

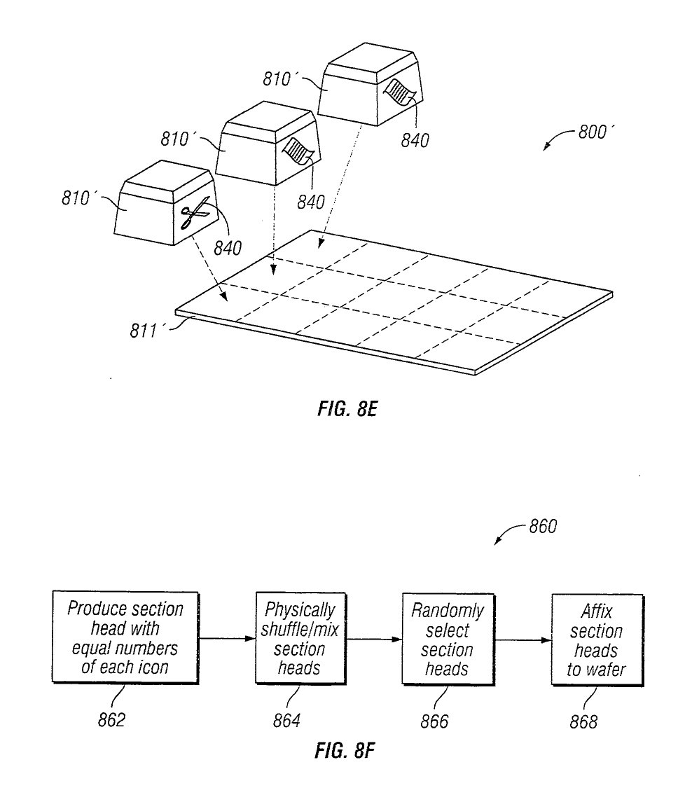

In an alternate preferred embodiment shown in FIGS. 8A-8E, an element of strategy is introduced to play with the candy (800) of the present invention by allowing images (840) to be hidden from view to opposing players while being visible to the player who possesses the candy (800). One of the features that differentiates this embodiment from that of the candy (700) of FIGS. 7A-7E is that, as shown in the cross-sectional view of FIG. 8B, the recesses (830) have a steep wall (851) on the surface of each section (810) that bears an image (840) and an inclined, i.e., less steep, wall (852) on the surface of each section (810) opposite an image (840). The other feature that differentiates this embodiment from that of the candy (700) of FIGS. 7A-7E is that, as shown in the perspective view of FIG. 8A and the cross-sectional view of FIG. 8C, the sections (810) form a PxQ matrix where P is greater than one (and P<Q). In the embodiment shown in FIG. 8A the sections (810) form a 3×5 matrix.

To begin play with the candy (800) of FIG. 8A, a player holds the candy (800) in a playing orientation, i.e., by rightmost end of the candy (800), and chooses which of the three leftmost sections (810) to break off. The opposing player does an analogous process and the players compare the images (840) of the sections (810) which are broken off to see who wins the round. Depending on the rules agreed to between the players beforehand, the winning player may be rewarded with the losing section (810) from the losing player. Exemplarily, FIG. 8D shows the candy (800) of FIG. 8A with the center section (810.x) at the leftmost end missing because it has been broken away. Depending on the rules agreed upon beforehand, in playing the next round the player possessing the candy of FIG. 8D may choose among the two remaining leftmost sections (810), or may choose among the two remaining leftmost sections (810) and the center section (810) in the second row from the left. More generally stated: the players may agree that all the sections (810) in one row have to be used prior to proceeding to the sections (810) in the next row, or that any exposed sections (810) (which in the case of the orientation of FIG. 8A are any sections (810) with an exposed left side) may be used in a round of play.

Whereas the candy (800) of FIG. 8A may be manufactured by a pseudo-random stamping process analogous to that described in conjunction with FIG. 7D, an alternative manufacturing method where section “heads” (810′) are produced first and then bonded to a wafer (811′) is shown in the flowchart of FIG. 8F and illustrated in FIG. 8E. According to this method (860), a large number of section heads (810′) are produced (862) with the images (840) imprinted on the section heads (810′) being roughly evenly divided between each of the icons from which the images (840) are selected. (By “roughly” it is meant that the number of head section bearing each of the icons is preferably with 10% of each other, more preferably 1% of each other, and still more preferably with 0.1% of each other.) Then the section heads (810′) are mixed (864) together in a bin to randomize the spatial distribution of images (840) born by the section heads (810′). The section heads (810′) are then selected from the bin and affixed (868) to a substrate wafer (811′). FIG. 8E shows the section heads (810′) for the three leftmost sections (810) located above the wafer (811′). According to the preferred embodiment, the section heads (810′) are chocolate and the wafer (811′) is chocolate or a chocolate-coated cookie or cracker, and the sections heads (810′) are affixed to the wafer (811′) by applying a coating of melted chocolate to the wafer (811′) and placing the section heads (810′) are appropriate positions on the wafer (811′) while the chocolate is still liquid.

It should be noted that the above-described embodiments have their hidden images revealed by irreversible transformative processes, e.g., the breaking away or consumption of sections or the consumption of layers. The candies of the above-described present invention are manufactured and purchased with the randomness of the images an integral part of the unitary candies. This—as opposed to, for instance, having a collection of candy balls imprinted with images in a container where the candy balls can be rearranged by shaking—makes the selection of which candy/candies to purchase and the purchasing of the candy/candies exciting parts of the entertainment process according to the present invention. Furthermore, the irreversible nature of the process through which images are revealed—as opposed to, for instance, having separate candies imprinted with images, whether randomly arranged spatially or ordered, which, it should be noted, may be used multiple times—adds drama and excitement to the entertainment of the present invention since reversible processes associated with play with non-integrally formed candies do not divide time into a before period and after period, and are therefore inherently less dramatic.

However, it should be noted that a candy dispenser which randomly dispenses separate candies imprinted with images, or a candy dispenser that releases separate candies imprinted with randomized images in an ordered sequence, may also be considered within the scope of the present invention. For instance, as shown in FIG. 12, the present invention may be a spring-loaded candy dispenser (1200) as is well-known in the art which dispenses candies (1210) in an ordered sequence, where the candies have been imprinted with images (not visible because they are on the underside of each candy (1210) so as not to be visible until released from the dispenser (1200)) such that the order of the images in the sequence has been randomized. Candies (1210) are released from the dispenser (1200) by a lever (1230) which raises the top (1235) of the container (1200) so that candies may be pushed up and out of the dispenser (1200) by the spring (1205) at the bottom. Two players, each having a dispenser (1200), would play as described in detail above by comparing the images on the candies (1210) released from the dispenser (1200) on each round of play.

The foregoing descriptions of specific embodiments of the present invention have been presented for purposes of illustration and description. They are not intended to be exhaustive or to limit the invention to the precise forms disclosed, and it should be understood that many modifications and variations are possible in light of the above teaching. The embodiments were chosen and described in order to best explain the principles of the invention and its practical application, to thereby enable those skilled in the art to best utilize the invention and various embodiments with various modifications as are suited to the particular use contemplated. While many specifics have been described above, many other variations are possible. For instance: although the preferred embodiments are described as candies or confections, they may more generally be any edible, even a non-sweet edible, or another type of consumable, such as soap, for instance for bath time play; the icons may be written or graphical instructions for another type of game, such as truth or dare; the geometry of the layers may be different from those described; the overall shape of the candy may differ from that described; the candy may not include a holder, i.e., it may not be a “sucker”; images may be printed at multiple locations on a layer; only one set of stamps or stencils may be used, or two sets (one small and one large) of stamps or stencils may be used; other games or recreations involving the revealing of hidden images may be played; the number of layers may be small or large depending upon the game or other aspects of the usage; the candy may be made of a candy material other than what is particularly described—for instance, the candy material which forms the image in the slab geometry described in conjunction with FIG. 3 may be made of a non-hard candy such as a jell or gummy; a candy composed of planar slabs may have the images painted on the surfaces of the slabs rather than being cast into the slabs; layers may have different thicknesses; the edible may be a frozen edible, such as a popsicle; the planar slabs may have a non-rectangular circumference, such as a circular circumference; the game played may use a circular hierarchy, such as rock/paper/scissors, or may use a non-circular hierarchy, such as highest card wins, or may use a hierarchy which is neither circular or non-circular; substrate layers may have a variety of colors, such as two alternating colors or three colors in a repeating sequence, etc.; the break-away candy may have more than or less than the number of sections depicted in the figures; the recesses between sections may be sufficiently narrow that opposing player(s) cannot see the play images while the recesses are sufficiently wide that the player who owns the candy is able to see the play images; sections of the break-away candy may bear images on more than one surface, for instance sections may bear images on two opposite side surfaces or on all side surfaces; the images may be imprinted on the break-away candies during the initial molding by the mold which forms the overall geometry of the candy; the images may be printed on an inclined wall rather than a steep wall of each section; the candy may not be unitary and may not require an irreversible transformative process to reveal each hidden image—for instance, there may be separate, randomly ordered or pseudo-randomly ordered candies imprinted with images; what is referred to as rows in the above-described matrix of sections may just as well be referred to as columns, and vice versa; the section to be broken off first in the break-away bar version may be otherwise marked, or a section not bearing an image may be broken off first in game play; etc. Furthermore, it should be noted that an important advantage of the present invention is that the concept of the present invention is conducive to developing product lines. For instance: the product line could include a variety of different games; for a given type of game, the product line could include candies having differing numbers of layers or image bays; the icons may include wild cards or trump cards that beat all other icons; etc. Accordingly, it is intended that the scope of the invention should be determined not by the embodiments illustrated or the physical analyses motivating the illustrated embodiments, but rather by the appended Claims and their legal equivalents.

What is claimed is:

1. An entertainment comprising:
a first edible having first portions and second portions, said first portions bearing first images unpredictably selected from a set of icons, said second portions being positioned to obscure said first images on said first portions, each removal of one of said second portions revealing one of said first images on one of said first portions, and
a second edible having third portions and fourth portions, said third portions bearing second images unpredictably selected from said set of icons, said fourth portions being positioned to obscure said second images on said third portions, each removal of one of said fourth portions revealing one of said second images on one of said third portions, rounds of a game being played by comparing said first and second images.

2. The entertainment of claim 1 wherein said first and second edibles are packaged together.

3. The entertainment of claim 1 wherein said second portions are first break-away sections of said first edible and said fourth portions are second break-away sections of said second edible.

4. The entertainment of claim 3 wherein said first edible is packaged in a first wrapper perforated to tear into first tear-away sections at first boundries between said first portions and said first break-away sections of said first edible so that said first break-away sections, when separated from the rest of said first edible, may in held in said first tear-away sections of said wrapper, and said second edible is packaged in a second wrapper perforated to tear into second tear-away sections at second boundries between said third portions and said second break-away sections of said second edible so that said break-away second sections, when separated from the rest of said second edible, may in held in said second tear-away sections of said wrapper.

5. The entertainment of claim 1 wherein a first subset of said first portions are a second subset of said second portions, and a third subset of said third portions are a fourth subset of said fourth portions, so said first subset of said first portions and said second subset of said second portions play dual roles of bearing and obscuring a fifth subset of said first images, and said third subset of said third portions and said fourth subset of said fourth portions play dual roles of bearing and obscuring a sixth subset of said second images.

6. The entertainment of claim 1 wherein said removals are irreversible transformations of said first and second edibles.

7. The entertainment of claim 6 wherein said removals are performed by eating said first and second edibles.

8. The entertainment of claim 1 wherein said first and second portions are layers of said first edible, and said third and fourth portions are layers of said second edible.

9. The entertainment of claim 8 wherein said edible is hard, thereby promoting consumption by licking or sucking and discouraging consumption by chewing, thereby making the evolution in size and shape of the edible during consumption predictable.

10. The entertainment of claim 1 wherein flavor changes signal visibility of said first images and said second images.

11. The entertainment of claim 1 wherein said icons have a circular hierarchy.

12. The entertainment of claim 1 wherein said first and second edibles are candies.

13. The entertainment of claim 1 wherein said first portions of said first edible and said third portions of said second edible are sections arranged in a N×M matrix, where N is greater than one and is a number of rows and M is greater than one and is a number of columns.

14. The entertainment of claim 1 wherein said first images are on first surfaces of said first portions facing a first direction along a first longitudinal axis of said first edible, and said first edible includes a first orientation piece having a distinguishing shape and indicating said first direction, and said second images are on second surfaces of said second portions facing a second direction along a second longitudinal axis of said second edible, and said second edible includes a second orientation piece having said distinguishing shape and indicating said second direction.

15. The entertainment of claim 14 wherein said first orientation piece is one of said second portions and said second orientation piece is one of said fourth portions.

16. The entertainment of claim 1 wherein said set of said icons are a heart, a bow and an arrow.

17. The entertainment of claim 16 wherein said heart has a more probable appearance than said bow or said arrow upon said each removal of one of said second portions and upon said each removal of one of said fourth portions.

18. A system of edible amusements for play by two players, comprising: two candies for use by said two players, said two candies taken from a batch of q candies having a plurality r of ordered series of m visual images of icons, each of said visual images being hidden until revealing action is taken by a player, said icons having a cardinality of n, r being large to provide play based on an unpredictable sequence of said icons in each of said two candies.

19. The system of edible amusements of claim 21 wherein q<n^{m} and n^{m}>1,000 and r>q/2.

20. A method for manufacturing an edible for a game of chance comprising the steps of:
providing blocks, each of said blocks bearing an image of an icon selected from a set of icons;
selecting a group of said blocks in a fashion so said images on said group of blocks are unpredictable; and
attaching said blocks together so that said images on said group of blocks are hidden.

21. The method of claim 20 wherein said selecting step includes mixing said blocks together in a container to spatially randomize the arrangement of said blocks.

22. The method of claim 20 wherein each of said images on each of said blocks has a protruding, surrounding frame, and wherein said attaching of said blocks includes the steps of:
abutting said blocks so that a subset of said surrounding frames press against neighboring ones of said blocks to form sealed chambers with said images within; and
coating said abutting blocks with an edible coating.
